(19) United States
(12) Patent Application Publication
(10) Pub. No.: US 2008/0192041 A1
(43) Pub. Date: Aug. 14, 2008

(54) LIQUID CRYSTAL DISPLAY FOR MULTI-SCANNING AND DRIVING METHOD THEREOF

(75) Inventors: Yu-hsi Ho, Hsin-Chu City (TW); Yao-jen Hsieh, Hsin-Chu City (TW); Chih-wei Wang, Hsin-Chu City (TW)

Correspondence Address: MADSON & AUSTIN, 15 WEST SOUTH TEMPLE, SUITE 900, SALT LAKE CITY, UT, 84101, US

(73) Assignee: Au Optronics Corp., Hsin-Chu (TW)

(21) Appl. No.: 11/780,043

(22) Filed: Jul. 19, 2007

(30) Foreign Application Priority Data
Feb. 14, 2007 (TW) 096105509

(51) Int. Cl. G09G 5/00

(52) U.S. Cl. 345/212

(57) ABSTRACT

A liquid crystal display includes a system circuit, a source driver, a gate driver, and a plurality of pixel units. The system circuit is used for generating a first scan line clock signal, a second scan line clock signal, a first scan line control signal, and a second scan line control signal, based on a horizontal synchronous signal and a vertical synchronous signal. The source driver is used for generating a data signal voltage. The gate driver includes a first shift register, a second shift register and a plurality of logic circuits. The first shift register is used for generating a first gate-on signal in response to the first scan line control signal after the first scan clock signal is triggered. The second register is used for generating a second gate-on signal in response to the second scan line control signal after the second scan clock signal is triggered. The plurality of logic circuits electrically coupled to the first and second shift registers are used for selectively outputting a scan signal from the first and the second gate-on signals. The plurality of pixel units, whereby each pixel unit includes a transistor and a liquid crystal capacitor having liquid crystal molecules, and alignment of liquid crystal molecules in each liquid crystal capacitor is varied according to the data signal voltage when the transistor of each pixel unit is turned on by the scan signal from the gate driver.

### BACKGROUND OF THE INVENTION

1. Field of the Invention

The present invention relates to a liquid crystal display and a gate driver thereof, and more particularly, to a liquid crystal display for multi-scanning and the gate driver thereof.

2. Description of the Prior Art

With a rapid development of monitor types, novelty and colorful monitors with high definition, e.g., liquid crystal displays (LCDs), are indispensable components used in various electronic products such as mobile phones, personal digital assistants, digital cameras, desktop computers and notebook computers.

Please refer to FIG. 1, which shows a functional block diagram of a liquid crystal display 10 according to the prior art. The liquid crystal display 10 includes a liquid crystal display panel 12, a plurality of gate drivers 14a, 14b and 14c, and a plurality of source drivers 16. The liquid crystal display panel 12 includes a plurality of pixel units 20. For example, the liquid crystal display panel 12 with 1024 by 768 pixel units and the scanning frequency of 60 Hz contains a number of 1024×768 pixel units 20, and the display interval of each frame is about 1/60=16.67 ms. The liquid crystal display panel 12 requires a number of 768 scan lines to control all pixel units 20. Suppose that a gate driver chip with 256 channels, the liquid crystal display panel 12 requires three gate drivers 14a, 14b and 14c to control the number of 768 scan lines. Each gate driver 14a, 14b and 14c may be function as a shift register, whose function is to sequentially output scanning signal to turn on each transistor 22 of the pixel units 20 row by row in a period of time (16.67 ms/768=21.7 μs), meanwhile, the capacitor 24 of each pixel unit 20 is charged to a corresponding voltage level based on the data signal voltage generated in the time period of 21.7 μs from the source driver 16, to show various gray levels. After the charge of a row of pixel units 20 is finished, the gate driver 14 stops outputting the scanning signal to this row, and outputs the scanning signal to turn on the transistors 22 of the pixel units 20 of the next row, and then the pixel units 20 of the next row will be charged based on the data signal voltage from the source driver 16. Sequentially, the above-mentioned mechanism is repeated until all the scan lines have been scanned once, and then another a new scanning period for a next frame will be repeated from the first scan line.

To improve quality of display, a technology called multi-frame scanning for the liquid crystal display has been developed recently. In other words, the gate drivers 14a, 14b and 14c generate scanning signals at least twice to each scan line in the display interval of each frame (16.67 ms). As a result, the transistor 22 of the pixel units 20 of each row may be turned on more than twice, such that the liquid crystal capacitor 24 is charged more than twice based on the data signal voltage. Please also refer to FIG. 2, an illustration of a timing diagram of part of signals when the liquid crystal display 10 of FIG. 1 performs the multi-frame scanning mechanism. From the view of FIG. 2, after being triggered by pulse C of scan line clock signal YDIO, the gate driver 14a may, based on scan driving signal YOED, output pulse D of scanning signal applied to the scan line G1 to turn on the transistor of pixel units 20 of the first row. On the other hand, the transistors of all pixel units 20 of the first row, which are electrically coupled to the scan line G1, are turned on by the pulse D of scanning signal, the pixel units 20 electrically coupled to the scan line G1 may be charged to a corresponding voltage level based on the data signal voltage generated from the source driver 16, to show various gray levels. Each gate driver 14a, 14b or 14c may be deemed as a shift register, that is, based on scan driving signal YOED, output pulse D of scanning signal applied to scan lines G2, . . . , G768 after the second row at every cycle of the scan clock signal YCLK and turn on the transistor 22 of the pixel units 20 accordingly. After the gate driver 14a outputting the pulse D of scanning signal applied to scan line G256, the gate driver 14b may output pulse D to the scan line G257 based on the scan driving signal YOED Meanwhile, being triggered by the pulse E of synchronous signal YDIO, the gate driver 14a may start generating the pulse B applied to the scan line G1 based on the scan driving signal YOEB so as to turn on the transistor 22 of the pixel units 20 of the first row again. When the transistor 22 of pixel units 20 is being turned on by pulse B of scanning signal, the pixel units 20 of the first row are charged to the voltage corresponding to the data signal voltage from the source driver 16, to show various gray levels; then scan lines G2, . . . , G256 may turn on transistor 22 of pixel units 20 again in response to the pulse B of scanning signal, to show various gray levels.

To avoid the possibility that the pixel unit 20 is input by two kinds of various data signal voltages at the same time, one gate driver 14a, 14b or 14c can only be fed one of the two scan driving signals YOED or YOEB at one time. For instance, after outputting the pulse D of scanning signal to scan lines G257, . . . , G512 in response to the scan driving signal YOED, the gate driver 14b may receive another scan driving signal YOEB and outputs the pulse B of scanning signal to the scan lines G257, . . . , G512.

However, with current development, a number of channels of a gate driver is gradually increased to reduce the quantity of the gate driver required by the liquid crystal display. Conventionally, a gate driver includes a number of 256 channels; however, the gate driver with 512 or even 1024 channels has been developed. Due to the fact that liquid crystal display panel can not be driven by the multi-scanning method for the reason that the gate drivers with 512 or more channels fail to receive various scan driving signals YOED and YOEB at the same time, it is necessary to configure a circuit within a gate driver to solve the problem.

### SUMMARY OF THE INVENTION

Accordingly, an objective of the present invention is to provide a liquid crystal display for multi-scanning and a gate driver used therein, such that the liquid crystal display receives various scan line driving signals to generate multiple scanning signals to solve the existing prior art problem.

Briefly summarized, the claimed invention provides a gate driver for driving a liquid crystal panel. The gate driver comprises a first shift register for generating a first gate-on signal in response to the first scan line control signal after a first scan clock signal is triggered, a second register for generating a second gate-on signal in response to the second scan line control signal after a second scan clock signal is triggered, and a plurality of logic circuits electrically coupled to the first and second shift registers for selectively outputting a scan signal from the first and the second gate-on signals to the liquid crystal panel.

According the present invention, a liquid crystal display includes a system circuit, a source driver, a gate driver, and a plurality of pixel units. The system circuit is used for generating a first scan line clock signal, a second scan line clock signal, a first scan line control signal, and a second scan line control signal, based on a horizontal synchronous signal and a vertical synchronous signal. The source driver is used for generating a data signal voltage. The gate driver includes a first shift register, a second shift register and a plurality of logic circuits. The first shift register is used for generating a first gate-on signal in response to the first scan line control signal after the first scan clock signal is triggered. The second register is used for generating a second gate-on signal in response to the second scan line control signal after the second scan clock signal is triggered. The plurality of logic circuits electrically coupled to the first and second shift registers are used for selectively outputting a scan signal from the first and the second gate-on signals. The plurality of pixel units, whereby each pixel unit comprising a transistor and a liquid crystal capacitor having liquid crystal molecules, and alignment of liquid crystal molecules in each liquid crystal capacitor is varied according to the data signal voltage when the transistor of each pixel unit is turned on by the scan signal from the gate driver.

According the present invention, a method of multi-scanning for a liquid crystal display, the method comprises the step of (a) generating a first scan line clock signal, a second scan line clock signal, a first scan line control signal, and a second scan line control signal, based on a horizontal synchronous signal and a vertical synchronous signal; (b) generating a first gate-on signal in response to the first scan line control signal after the first scan clock signal is triggered; (c) generating a second gate-on signal in response to the second scan line control signal after the second scan clock signal is triggered; (d) selectively outputting a scan signal from the first and the second gate-on signals; and (e) displaying an image based on a data signal voltage in response to the scan signal.

According the present invention, a liquid crystal display comprises a system circuit, a source driver, a gate driver, and a plurality of pixel units. The system circuit is used for generating a plurality of scan line clock signals, and a plurality of scan line control signals, based on a horizontal synchronous signal and a vertical synchronous signal. The source driver is used for generating a data signal voltage. The gate driver comprises a plurality of shift registers, a plurality of logic circuits. Each shift register electrically coupled to one of the plurality of scan line clock signals and one of the plurality of scan line control signals, is used for generating a gate-on signal in response to the scan line control signal after the scan clock signal is triggered. The plurality of logic circuits electrically coupled to the plurality of shift registers, for selectively outputting a scan signal from the plurality of gate-on signals outputted from the plurality of shift registers. Each pixel unit comprises a transistor and a liquid crystal capacitor having liquid crystal molecules, and alignment of liquid crystal molecules in each liquid crystal capacitor is varied according to the data signal voltage when the transistor of each pixel unit is turned on by the scan signal from the gate driver.

These and other objectives of the present invention will become apparent to those of ordinary skill in the art after reading the following detailed description of the preferred embodiment that is illustrated in the various figures and drawings.

### BRIEF DESCRIPTION OF THE DRAWINGS

FIG. 1 shows a functional block diagram of a liquid crystal display 10 according to the prior art.

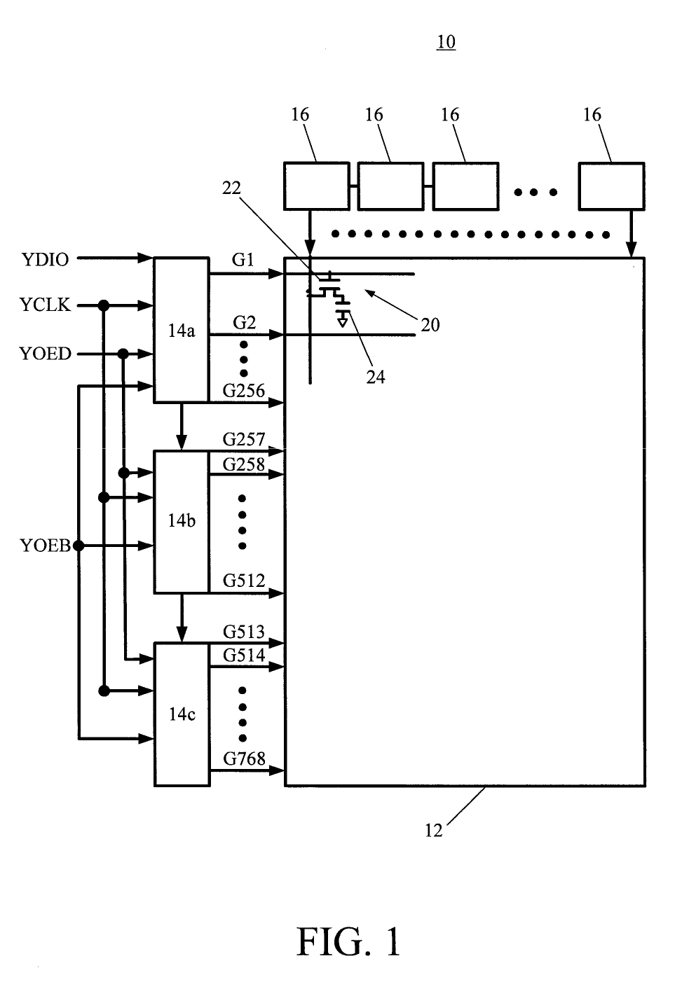

FIG. 2 illustrates a timing diagram of part of signals when the liquid crystal display of FIG. 1.

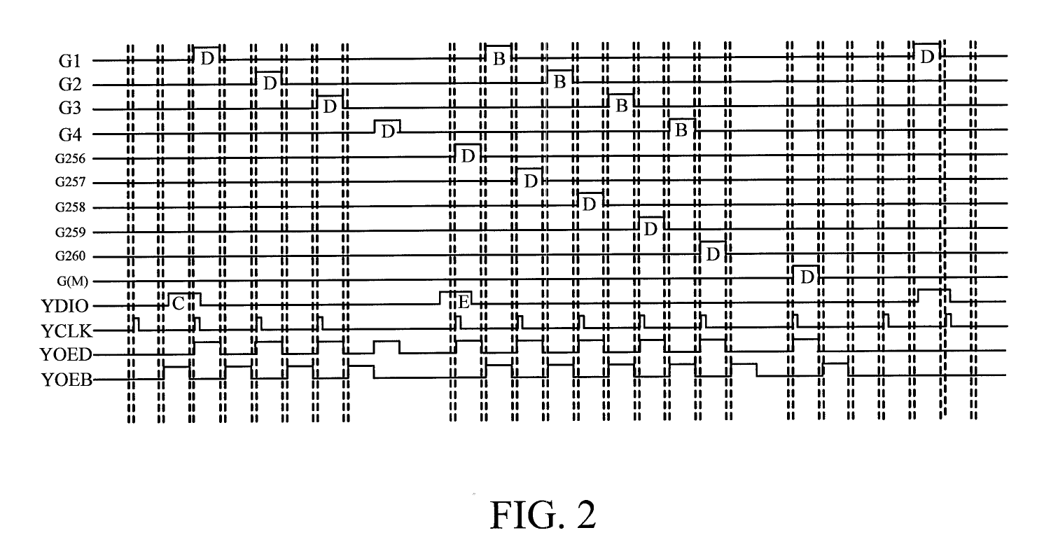

FIG. 3 shows a schematic diagram of the liquid crystal display according to the present invention.

FIG. 4 shows a functional block diagram of the gate driver as shown in FIG. 3.

FIG. 5 illustrates a timing diagram of the signals of the transmission lines as shown in FIG. 4.

### DETAILED DESCRIPTION OF THE INVENTION

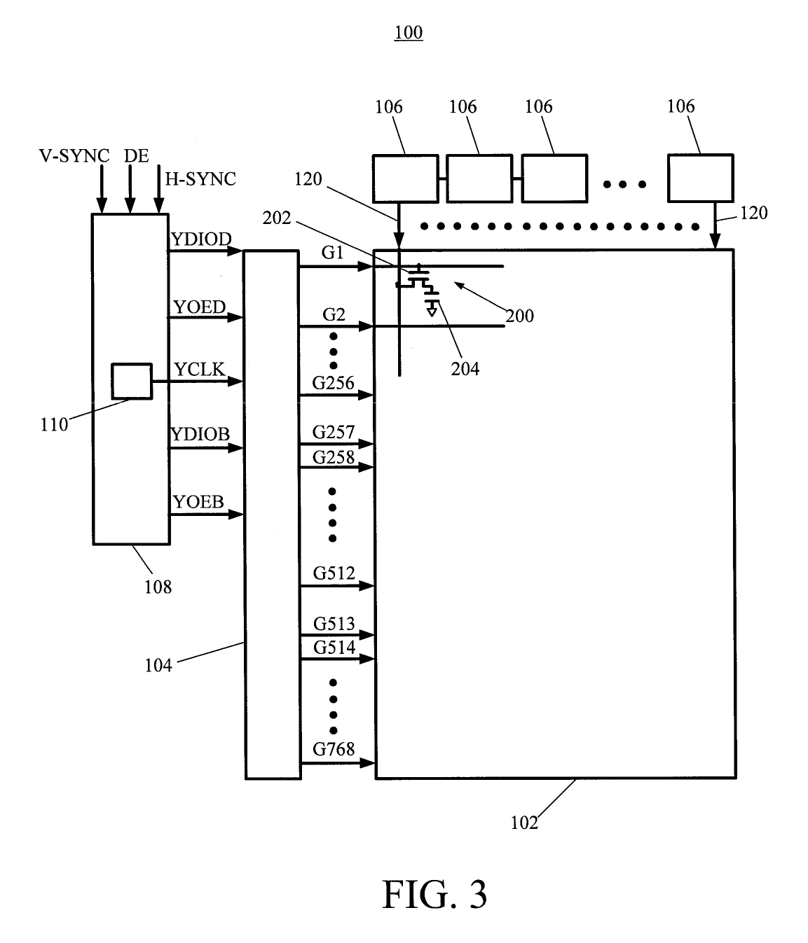

Please refer to FIG. 3, which shows a schematic diagram of the liquid crystal display 100 according to the present invention. The liquid crystal display 100 comprises a liquid crystal display panel 102, a gate driver 104, a plurality of source drivers 106 and a system circuit 108. The liquid crystal display panel 102 comprises a plurality of pixel units 200, each pixel unit 200 including a switch transistor 202 and a liquid crystal capacitor 204. Liquid crystal molecules in the liquid crystal capacitor 204 may adjusts their alignments based on the voltage drop across the liquid crystal capacitor 204. The system circuit 108, in response to the horizontal synchronous signal H-Sync and the vertical synchronous signal V-Sync or the data-enabling signal DE, generates a first scan line clock signal YDIOD, a second scan line clock signal YDIOB, a first scan line control signal YOED and a second scan line control signal YOEB applied to the gate driver 104. Furthermore, the system circuit 108 also comprises a clock generator 110 for generating a clock signal YCLK applied to the gate driver 104. For a liquid crystal display panel 102 with 1024 by 768 pixel units and the scanning frequency of 60 Hz, the display interval of each frame is about 1/60=16.67 ms. The gate driver 104 comprises a number of 768 channels, each channel being respectively connected to one of scan lines G1-G768. A plurality of source drivers 106 comprises a number of 1024 channels, each channel being connected to a data line 120. As it is, the using quantity of the gate drivers 104 may be regulated according to the quantity of channels thereof and the resolution of liquid crystal display panel 102. For instance, a liquid crystal display panel with 1200 by 800 pixel units requires two gate drivers with a number of 512 channels to control a number of 800 scan lines.

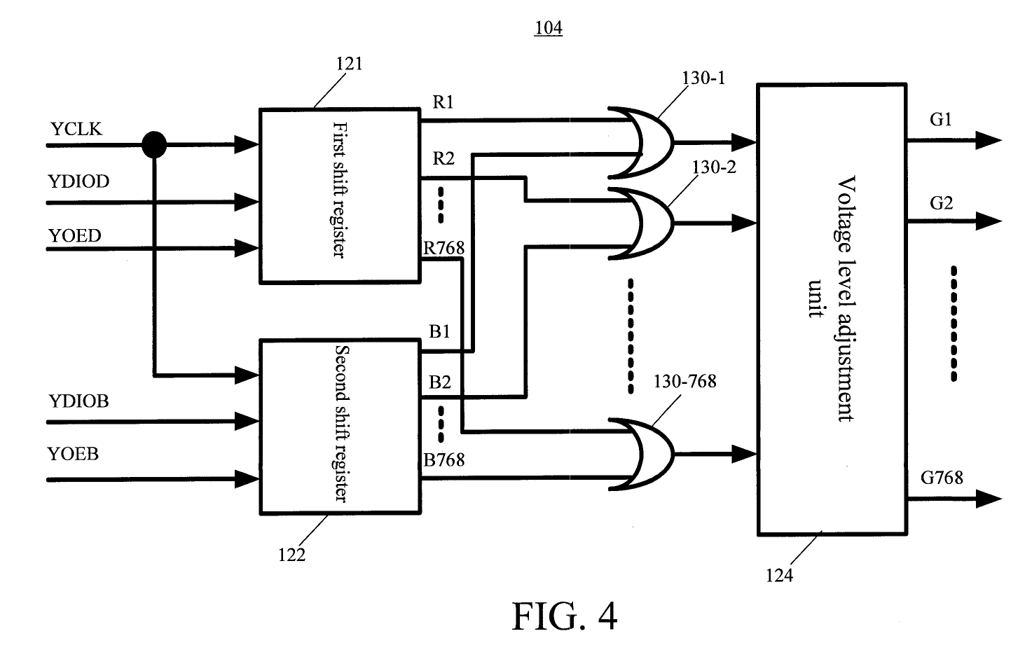

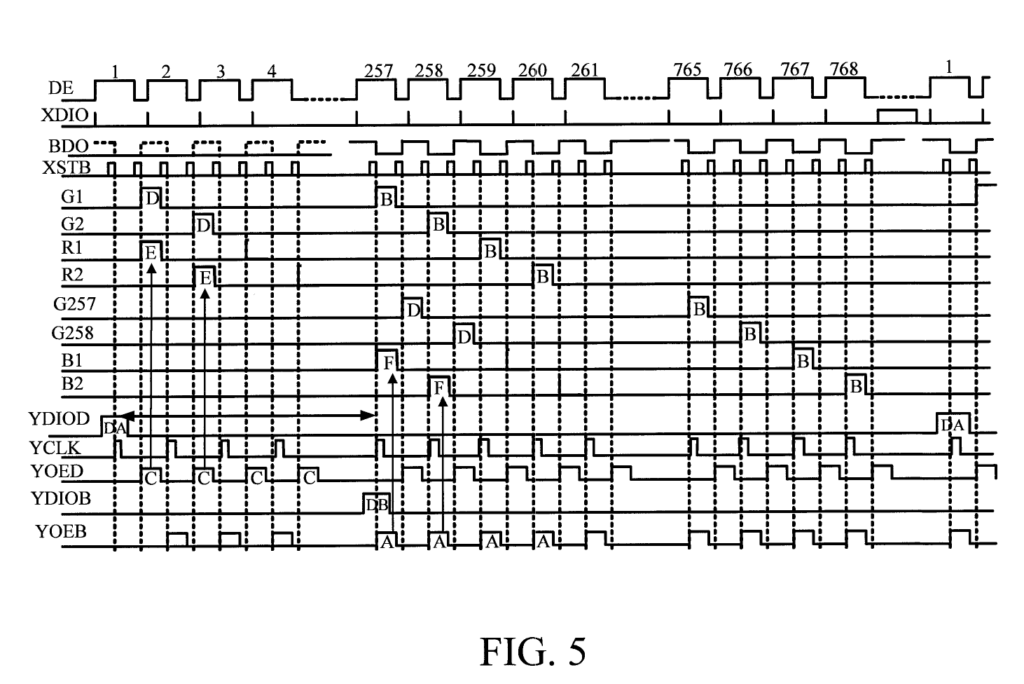

Please also refer to FIGS. 3, 4 and 5. FIG. 4 shows a functional block diagram of the gate driver 104 as shown in FIG. 3, and FIG. 5 illustrates a timing diagram of the signals of the transmission lines as shown in FIG. 4. The gate driver 104 comprises a first shift register 121, a second shift register 122, a plurality of logic circuits 130-1, 130-2, . . . ,130-768 and a voltage level adjustment unit 124. After being triggered by the pulse DA of the first scan line clock signal YDIOD, the first shift register 121, in response to the first scan line control signal YOED, outputs a synchronous first gate-on signal (that is the pulse E) applied to the transmission line R1. Therefore, the pulse width of the first gate-on signal is almost the same as that of the first scan line control signal YOED. Then, the first shift register 121, in response to the pulse C of the first scan line control signal YOED, sequentially outputs the synchronous pulse E applied to the transmission lines R2, R3, . . . , R768, at every cycle of the scan frequency signal YCLK (16.67 ms/768=21.7 μs). It is supposed that, in the display interval of each frame 16.67 ms (that is, the interval of the pulse DA of the scan line clock signal YDIOD being triggered or the interval of the pulse DB of the scan line clock signal YDIOB being triggered), the pulse DB generated by the second scan line clock signal YDIOB is also applied to the second shift register 122 5.56 ms (256×21.7 μs) after the transmission line R1 generating the pulse E. Under such circumstance, the transmission line B1 generates the second gate-on signal (the pulse F) in response to the synchronous output of the second scan line control signal YOEB (the pulse A), therefore, the pulse width of the second gate-on signal is almost the same as that of the second scan line control signal YOEB. On the other hand, the second shift register 122, in response to the pulse A of the second scan line control signal YOEB, sequentially outputs the synchronous pulse F applied to the transmission lines B2, B3, . . . , B768, at every cycle of the scan clock signal YCLK (16.67 ms/768=21.7 μs). The logic circuit 130-1 is electrically coupled to the transmission lines R1 and B1 for selectively outputting a scan signal from the first gate-on signal and the second gate-on signal, and then the selected signal is applied to the scan line G1. Similarly, the logic circuit 130-2 is electrically coupled to the transmission lines R2 and B2 for selectively outputting a scan signal from the first gate-on signal and the second gate-on signal, and then the selected signal is applied to the scan line G2. Sequentially, the logic circuit 130-768 is electrically coupled to the transmission lines R768 and B768 for selectively outputting a scan signal from the first gate-on signal and the second gate-on signal, and then the selected signal is applied to the scan line G768. Logic circuits 130-1, 130-2, . . . , 130-768 may be an OR logic gate or another equivalent circuit capable of executing OR logic operations. As shown in FIG. 5, the transmission line R1 generates the pulse E and the transmission line B1 generates the pulse F are not at the same time. Therefore, after the OR logic operations via the logic circuit 130-1, the pulse D of scanning signal output from the logic circuit 130-1 occurs when the transmission line R1 transmits the pulse E, and the pulse B occurs when the transmission line B1 transmits the pulse F. Finally, after the adjustment by the voltage level adjustment unit 124, the scanning signals are transmitted to the scan line G1 to turn on the transistor 202 of the pixel unit 200 positioned on the scan line G1. On the other hand, in the interval of occurrences of the pulses D, B, the liquid crystal capacitor 204 adjusts the alignment of liquid crystal molecules therein according to the data signal voltage generated from the source driver 106, to show various gray levels. Similarly, the operating mechanism of the logic circuit 130-1 is applicable to other logic circuits 130-2, 130-3, . . . , 130-768.

In FIGS. 4 and 5, the gate driver 104 uses the two scan line clock signals YDIOD and YDIOB to control the generation of the two scan line control signals YOED and YOEB, such that each scan line is scanned twice in the display interval of each frame. In other words, during the period of the pulse DA (or DB) of the scan line clock signals YDIOD (or YDIOB) being triggered (that is, in the display interval of each frame), each scan line among G1-G768 may output the pulses of scanning signals twice, pulses D and B. In another embodiment, a gate driver may also use more than three scan line clock signals to control the generation of the scan line control signals thereof, that is, each scan line may be scanned more than three times in the display interval of each frame.

Compared to the prior art, the liquid crystal display according to the present invention configures a plurality of logic circuits within the gate driver, such that a singular gate driver may receives various pulses of scan line control signals so as to output multiple pulses of scanning signals. As a result, the transistor of the pixel unit of each scan line may be turned on more than twice for multi-scanning.

As is understood by a person skilled in the art, the foregoing preferred embodiments of the present invention are illustrative rather than limiting of the present invention. It is intended that they cover various modifications and similar arrangements be included within the spirit and scope of the appended claims, the scope of which should be accorded the broadest interpretation so as to encompass all such modifications and similar structure.

What is claimed is:

1. A gate driver for driving a liquid crystal panel, comprising:
a first shift register for generating a first gate-on signal in response to the first scan line control signal after a first scan clock signal is triggered;
a second register for generating a second gate-on signal in response to the second scan line control signal after a second scan clock signal is triggered; and
a plurality of logic circuits electrically coupled to the first and second shift registers for selectively outputting a scan signal from the first and the second gate-on signals to the liquid crystal panel.

2. The gate driver of claim 1, wherein each of the plurality of logic circuits performs an OR operation for the first gate-on signal and the second gate-on signal.

3. The gate driver of claim 1, wherein the first shift register and the second shift register are used for periodically outputting the first gate-on signal and the second gate-on signal by a cycle of a clock signal based on the first scan line control signal and the second scan line control signal, after the first scan line clock signal and the second scan line clock signal are triggered, respectively.

4. The gate driver of claim 1, wherein a trigger moment of the first scan line control signal is different from that of the second scan line control signal.

5. The gate driver of claim 1, further comprising a voltage level adjustment unit electrically coupled to the plurality of logic circuits for adjusting voltage level of the scan signal.

6. A liquid crystal display comprising:
a system circuit, for generating a first scan line clock signal, a second scan line clock signal, a first scan line control signal, and a second scan line control signal, based on a horizontal synchronous signal and a vertical synchronous signal;
a source driver for generating a data signal voltage;
a gate driver, comprising:
a first shift register for generating a first gate-on signal in response to the first scan line control signal after the first scan clock signal is triggered;
a second register for generating a second gate-on signal in response to the second scan line control signal after the second scan clock signal is triggered; and
a plurality of logic circuits electrically coupled to the first and second shift registers for selectively outputting a scan signal from the first and the second gate-on signals; and
a plurality of pixel units, wherein each pixel unit comprising a transistor and a liquid crystal capacitor having liquid crystal molecules, and alignment of liquid crystal molecules in each liquid crystal capacitor is varied according to the data signal voltage when the transistor of each pixel unit is turned on by the scan signal from the gate driver.

7. The liquid crystal display of claim 6, wherein each of the plurality of logic circuits performs an OR operation for the first gate-on signal and the second gate-on signal.

8. The liquid crystal display of claim 6, wherein the gate driver further comprises a voltage level adjustment unit electrically coupled to the plurality of logic circuits for adjusting voltage level of the scan signal.

9. The liquid crystal display of claim 6, wherein a width of the first scan line control signal substantially equals to that of the first gate-on signal.

10. The liquid crystal display of claim 6, wherein a width of the second scan line control signal substantially equals to that of the second gate-on signal.

11. The liquid crystal display of claim 6, further comprising a clock generator for generating a clock signal, wherein the first shift register and the second shift register are used for periodically outputting the first gate-on signal and the second gate-on signal by a cycle of the clock signal based on the first scan line control signal and the second scan line control signal, after the first scan line clock signal and the second scan line clock signal are triggered, respectively.

12. The liquid crystal display of claim 6, wherein a trigger moment of the first scan line control signal is different from that of the second scan line control signal.

13. A method of multi-scanning for a liquid crystal display, comprising:
(a) generating a first scan line clock signal, a second scan line clock signal, a first scan line control signal, and a second scan line control signal, based on a horizontal synchronous signal and a vertical synchronous signal;
(b) generating a first gate-on signal in response to the first scan line control signal after the first scan clock signal is triggered;
(c) generating a second gate-on signal in response to the second scan line control signal after the second scan clock signal is triggered;
(d) selectively outputting a scan signal from the first and the second gate-on signals; and
(e) displaying an image based on a data signal voltage in response to the scan signal.

14. The method of claim 13, wherein each of the plurality of logic circuits performs an OR operation for the first gate-on signal and the second gate-on signal.

15. The method of claim 13, wherein a width of the first scan line control signal substantially equals to that of the first gate-on signal.

16. The method of claim 13, wherein a width of the second scan line control signal substantially equals to that of the second gate-on signal.

17. The method of claim 13, wherein the step (b) comprises:
periodically outputting the first gate-on signal by a cycle of the clock signal based on the first scan line control signal, after the first scan line clock signal is triggered.

18. The method of claim 13, wherein the step (c) comprises:
periodically outputting the second gate-on signal by a cycle of the clock signal based on the second scan line control signal, after the second scan line signal is triggered.

19. The method of claim 13, wherein a trigger moment of the first scan line control signal is different from that of the second scan line control signal.

20. A liquid crystal display comprising:
a system circuit, for generating a plurality of scan line clock signals, and a plurality of scan line control signals, based on a horizontal synchronous signal and a vertical synchronous signal;
a source driver for generating a data signal voltage;
a gate driver, comprising:
a plurality of shift registers, wherein each shift register is electrically coupled to one of the plurality of scan line clock signals and one of the plurality of scan line control signals, for generating a gate-on signal in response to the scan line control signal after the scan clock signal is triggered;
a plurality of logic circuits electrically coupled to the plurality of shift registers, for selectively outputting a scan signal from the plurality of gate-on signals outputted from the plurality of shift registers; and
a plurality of pixel units, wherein each pixel unit comprising a transistor and a liquid crystal capacitor having liquid crystal molecules, and alignment of liquid crystal molecules in each liquid crystal capacitor is varied according to the data signal voltage when the transistor of each pixel unit is turned on by the scan signal from the gate driver.

21. The liquid crystal display of claim 20, wherein each of the plurality of logic circuits performs an OR operation for the plurality of gate-on signals.

22. The liquid crystal display of claim 20, wherein the gate driver further comprises a voltage level adjustment unit electrically coupled to the plurality of logic circuits for adjusting voltage level of the scan signal.

23. The liquid crystal display of claim 20, wherein each width of the plurality of scan line control signal is substantially identical.

24. The liquid crystal display of claim 20, further comprising a clock generator for generating a clock signal, wherein each shift register is used for periodically outputting the gate-on signal by a cycle of the clock signal based on the scan line control signal, after the scan line clock signal is triggered.

25. The liquid crystal display of claim 20, wherein a trigger moment of each scan line control signal is different.
